(19) United States
(12) Patent Application Publication
(10) Pub. No.: US 2013/0162825 A1
(43) Pub. Date: Jun. 27, 2013

(54) AVM TOP VIEW BASED PARKING SUPPORT SYSTEM

(71) Applicants: Daejoong Yoon, Seoul (KR); Jaeseob Choi, Hwasung-shi (KR)

(72) Inventors: Daejoong Yoon, Seoul (KR); Jaeseob Choi, Hwasung-shi (KR)

(73) Assignee: Hyundai Motor Company, Seoul (KR)

(21) Appl. No.: 13/625,584

(22) Filed: Sep. 24, 2012

(30) Foreign Application Priority Data
Dec. 23, 2011 (KR) 10-2011-0141009

(51) Int. Cl. H04N 7/18

(52) U.S. Cl. 348/148; 348/E07.085

(57) ABSTRACT

An AVM (Around View Monitoring) top view based parking support system using AVM, may include a camera unit including the AVM and photographing and acquiring images around a vehicle by using the AVM, and converting and synthesizing the acquired images into top view images, a parking space recognizing unit recognizing a parking space by periodically receiving the top view images generated from the camera unit and comparing top view images that may be sequentially continuous by using an image recognition technology, a control unit receiving vehicle traveling information from each sensor of the vehicle and determining and generating a parking path based on the vehicle traveling information with respect to the parking space recognized from the parking space recognizing unit, and a parking support unit receiving steering information of the vehicle and converting a display of the parking path generated in the control unit to correspond to the steering information.

### CROSS-REFERENCE TO RELATED APPLICATIONS

The present application claims priority to Korean Patent Application No. 10-2011-0141009, filed on Dec. 23, 2011, the entire contents of which is incorporated herein for all purposes by this reference.

### BACKGROUND OF THE INVENTION

1. Field of the Invention

The present invention relates to an around view monitoring (AVM) top view based parking support system, and more particularly, to an AVM top view based parking support system that provides an optimal parking position to a driver according to a parking trajectory by photographing images around a vehicle with AVM cameras mounted on front and rear and left and right portions of the vehicle and converting the photographed images into a top view mode to recognize a parking division mark around the vehicle and by recognizing an available parking space as well as a movement trajectory of the vehicle through registration of continuous images.

2. Description of Related Art

In general, a visual field of a driver who sits inside of a vehicle is configured to primarily face a front side. Therefore, since considerable parts of horizontal and rear visual fields of the driver are covered by a vehicle body, the visual field of the horizontal and rear sides is limited.

A visual field assisting means (for example, a side mirror) including a mirror for complementing the driver's visual field of a limited range has been generally used in order to solve the problem and in recent years, technologies including a camera means that photographs an external image of a the vehicle and provides the photographed external image to the driver tend have been applied to the vehicle.

Among them, at present, there is an around view monitoring (AVM) system that shows a 360° image, that is, in all directions around the vehicle by installing a plurality of cameras around the vehicle. The known technology is configured to solve a dead zone around the vehicle by installing a plurality of cameras photographing a zone around the vehicle and providing all-direction image around the vehicle photographed by the plurality of cameras to the driver.

However, the AVM system provides only a function to show the image around the vehicle to the driver and since the driver should directly judge a parking situation from the image provided through the AVM system while parking, the AVM system cannot be of help to parking.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a parking support system using around view monitoring (AVM) cameras mounted on front and rear and left and right portions of a vehicle, and more particularly, to an AVM top view based parking support system that acquires an image around the vehicle by using four cameras mounted on the vehicle, recognizes an around parking division mark under a parking environment by converting the acquired image into a top view (bird's eye view) and recognizes an available parking space as well as a movement trajectory of the vehicle through registration of continuous images at that time to provide an optimal parking position to a driver by considering a parking trajectory.

In an aspect of the present invention, an AVM (Around View Monitoring) top view based parking support system using AVM, may include a camera unit including the AVM and photographing and acquiring images around a vehicle by using the AVM, and converting and synthesizing the acquired images into top view images, a parking space recognizing unit recognizing a parking space by periodically receiving the top view images generated from the camera unit and comparing top view images that are sequentially continuous by using an image recognition technology, a control unit receiving vehicle traveling information from each sensor of the vehicle and determining and generating a parking path based on the vehicle traveling information with respect to the parking space recognized from the parking space recognizing unit, and a parking support unit receiving steering information of the vehicle and converting a display of the parking path generated in the control unit to correspond to the steering information.

The AVM top view based parking support system may further include an ultrasonic sensor unit including an ultrasonic sensor and recognizing the parking space through the ultrasonic sensor, wherein the ultrasonic sensor unit interlocks with the parking space recognizing unit, and wherein the parking space recognizing unit further uses data of the ultrasonic sensor unit in recognizing the parking space.

The parking space recognizing unit extracts feature points of continuous images by using an image recognition technology, matches feature points of two continuous images, deletes mismatched feature points, and matches effective feature points to recognize the parking space.

The control unit determines a parking position by considering a parking trajectory and the number of forward/backward movement times by matching the vehicle traveling information with the parking space recognized from the parking space recognizing unit.

The control unit determines whether an obstacle exists within the parking space by judging a difference in the periodically received top view images.

According to an exemplary embodiment of the present invention, images around a vehicle are acquired and converted into a top view image by using an AVM system, thereby recognizing a situation around the vehicle in real time and recognizing a parking space even in any direction around the vehicle.

Further, images around the vehicle are continuously photographed and registered and the continuous images are compared with each other to recognize a parking space and a parking line and a path which the vehicle passes is shown and an optimal parking space is displayed based thereon, thereby improving reliability in parking and improving accuracy.

In addition, a top view based image is provided to a driver and a parking process is visualized and provided, thereby improving stability for a parking support system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram showing a configuration of an AVM top view based parking support system according to an exemplary embodiment of the present invention.

FIG. 2 shows an image around a vehicle photographed from AVM.

FIG. 3 is a mimetic diagram showing a virtual modeling that converts the image around the vehicle into a top view type image.

FIG. 4 shows a top view type image acquired through conversion and synthesis by the virtual camera modeling.

FIGS. 5 to 8 show a parking space recognizing process of a parking space recognizing unit.

FIG. 9 is a plan view showing a structure of searching and setting a parking space by repeating the step.

FIG. 10 shows an exemplary embodiment of searching and setting the parking space of FIG. 9.

FIG. 11 shows another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

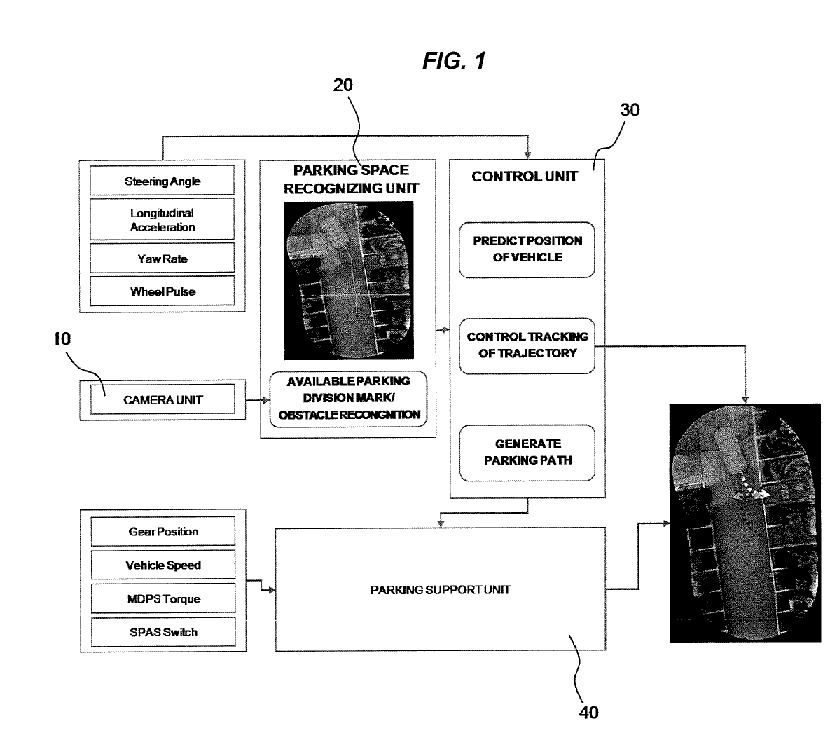

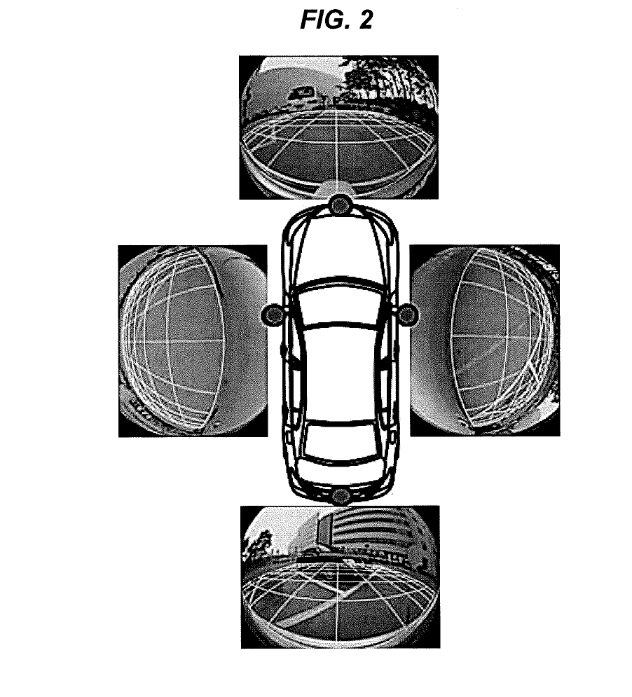

FIG. 1 is a block diagram showing a configuration of an AVM top view based parking support system according to an exemplary embodiment of the present invention and FIG. 2 shows an image around a vehicle photographed from AVM.

The AVM top view based parking support system according to the exemplary embodiment of the present invention includes a camera unit 10 to recognize a parking space around a vehicle.

The camera unit 10 according to the exemplary embodiment of the present invention may includes known around vie monitoring (AVM).

As shown in FIG. 2, the AVM is a known means that provides advantages of ensuring a visual field around the vehicle and solving a dead zone which a driver is difficult to view by installing a plurality of camera means acquiring images by photographing a zone around the vehicle in all directions of the vehicle and providing the images photographed through the plurality of camera means to a driver.

In the exemplary embodiment of the present invention, the AVM may preferably include a known wide-angle camera. Therefore, the image around the vehicle may be photographed in all directions, that is, 360° view, by the AVM.

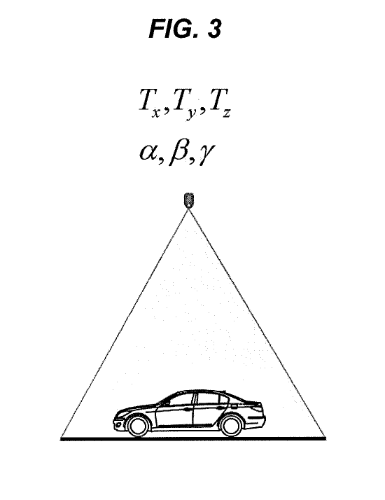

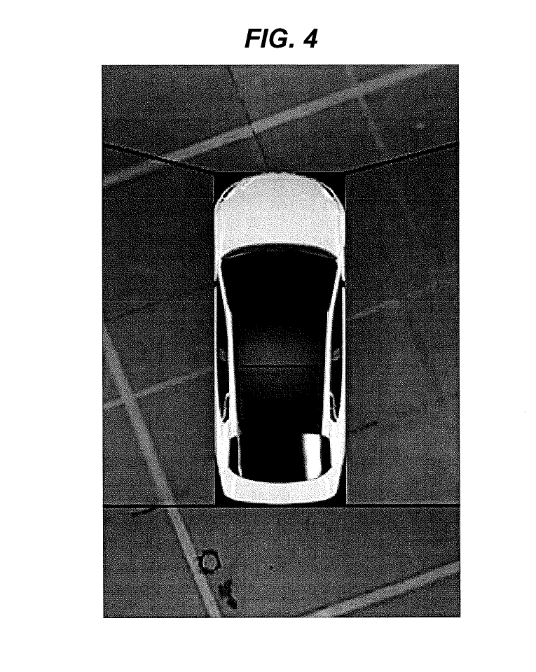

Meanwhile, as described above, the image around the vehicle photographed through the AVM is subjected to a virtual camera modeling shown in FIG. 3 by a control unit 30 (may be included in the AVM) controlling the AVM and converted and synthesized into a top view, that is, a bird's eye view to be converted into a 2D plane image shown in FIG. 4.

Therefore, the control unit 30 of the AVM may acquire a top view type image acquired by viewing the image around the vehicle of a visual field viewed from the top of the vehicle through the image processing the image of the zone around the vehicle.

The parking support system according to the exemplary embodiment of the present invention recognizes a parking position and supports parking by using the top view type image acquired as above.

When the top view image around the vehicle is acquired by the camera unit 10, a parking space recognizing unit 20 recognizes a parking space through the top view image.

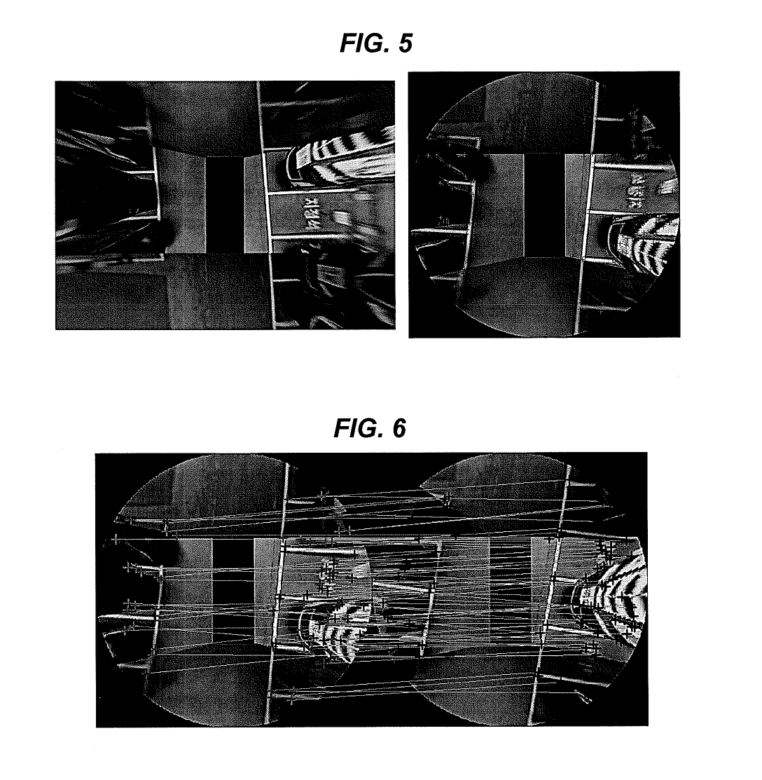

A parking space recognizing process of the parking space recognizing unit 20 is shown in FIGS. 5 to 8.

As shown in FIG. 5, the control unit 30 converts the image photographed by the AVM into the top view type to continuously and periodically acquire the top view images around the vehicle. The control unit 30 compares the top view images around the vehicle acquired as above with each other.

In this case, the parking space recognizing unit 20 compares two images which are continuous to each other from images periodically inputted to recognize a parking space and recognize a vehicle trajectory. Herein, a known image recognition technology is used.

A known corner detection technology may be used to compare the two continuous images. The corner detection technology as a known technology that extracts and recognizes corners of objects included in the images is used to judge a difference between the continuous images, during image recognition.

In particular, since corner information is an important reference point in a field such as a shape or tracking in the image processing and recognizing field, according to an exemplary embodiment of the present invention, a primary feature point is extracted by using the corner detection technology in order to recognize the top view type images around the vehicle which are continuously photographed.

In the exemplary embodiment of the present invention, a Harris corner detection technology which is the most representative among the corner detection technologies may be used. However, it is apparent that the exemplary embodiment of the present invention is not limited thereto.

When primary feature points of the two continuous images are extracted, the control unit 30 matches and compares the two continuous feature points with each other as shown in FIG. 6.

A known normalized cross correlation (NCC) technology is used for matching the two continuous feature points.

The NCC technology is a technology that normalizes two images which may be changed depending on an environment to be compared with each other for comparing the two images with each other and the control unit 30 of the present invention uses the NCC technology in order to normalize and compare two continuous images which are changed by the movement of the vehicle.

In this case, preferably, the control unit 30 uses brightness values of pixels in a 7×7 quadrangular area around the feature points of the two continuous images as a descriptor of the feature point and the respective feature points are matched with each other by normalizing the images with the NCC technology and similarity between the two images may be measured.

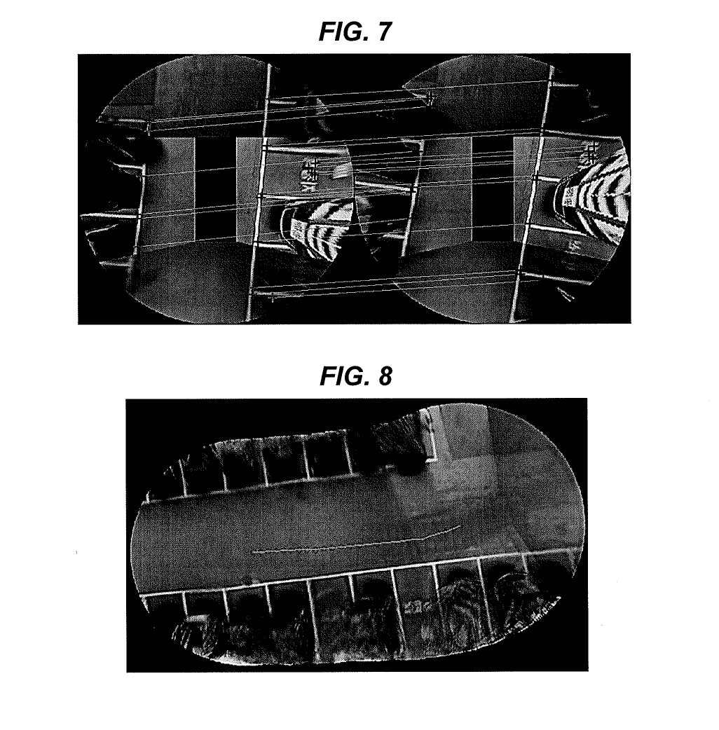

As described above, when the respective feature points of the two continuous normalized images are matched with each other, a step of deleting mismatched feature points is performed as shown in FIG. 7.

In this case, there is performed a step of extracting a difference in displacement and a difference in angle between the two continuous images through a similarity transformation model and deleting the mismatched feature points in order to compare only effective feature points through a random sample consensus (RANSAC) technology. The RANSAC technology is the known technology that predicts factors of a mathematical model from a set of a series of data including false information (mismatched feature point in an exemplary embodiment of the present invention) through repetitive operations and the control unit 30 according to the exemplary embodiment of the present invention may recognize and delete the mismatched feature points through the RANSAC technology.

When the mismatched feature points are deleted and the effective feature points are selected as above, a step of matching the images based on the predicted effective feature points is performed, as shown in FIG. 8. That is, while the steps of FIGS. 5 to 7 are consecutively performed, the continuous images continue to be matched as the vehicle moves, thereby recognizing the movement trajectory of the vehicle and estimating the position of the vehicle.

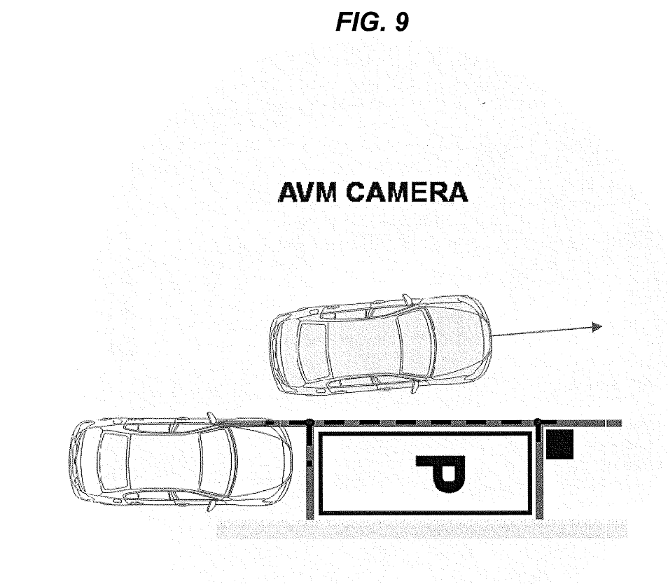

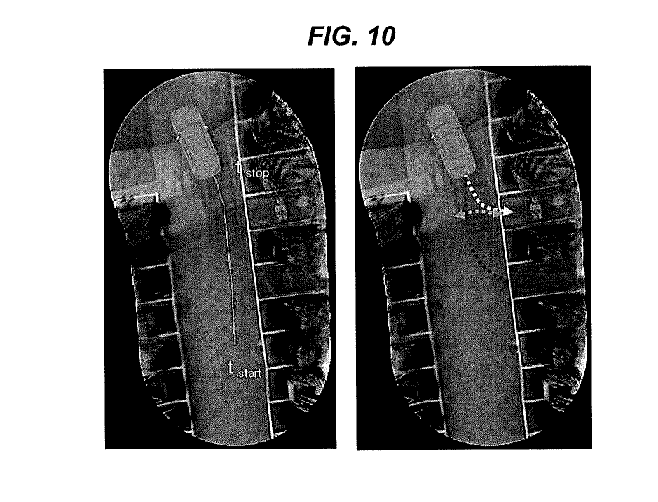

FIG. 9 is a plan view showing a structure of searching and setting a parking space by repeating the steps and FIG. 10 shows an exemplary embodiment of searching and setting the parking space of FIG. 9.

As described above, while the vehicle adopting the AVM top view based parking support system according to an exemplary embodiment of the present invention moves in a parking lot, the continuous images are compared by photographing the top view type image in real time to recognize the parking space. In this case, as shown in FIG. 9, when the parking space is recognized within the range of the top view image of the vehicle, the parking space recognizing unit 20 recognizes a traffic lane based on the continuously registered image to calculate a road width and a parking area.

In this case, the control unit 30 may receive vehicle traveling information from various sensors provided in the vehicle in order to generate a parking trajectory. In this case, received information may include, for example, a vehicle speed, a wheel pulse, an SAS, and the like.

When the photographed images are continuously registered as shown in FIG. 9, the images are registered according to the movement trajectory of the vehicle, the parking space recognizing unit 20 recognizes the traffic lane based on the images, and the control unit 30 calculates the parking area, as shown in FIG. 10. In this case, an obstacle within the parking space may be judged by using a difference image and the control unit 30 may select an appropriate parking space by considering a relative position of the position of the vehicle and the recognized parking space and displays an optimal parking position and provide the displayed optimal parking position to the driver. That is, the control unit 30 calculates the optimal parking position by considering the parking trajectory and the number of forward/backward movement times among candidate parking spaces selected as the parking space and displays and provides the calculated position to the driver through a parking support unit 40 to be described below, thereby supporting a driver's parking.

The parking support unit 40 of FIG. 1 provides the driver with the parking path set from the control unit 30 through a human machine interface (HMI) as described above.

That is, as shown in the figure, the parking support unit 40 serves to convert and display the parking path set from the control unit 30 as described above to correspond to the traveling information by receiving various pieces of traveling information of the vehicle, i.e., information regarding a gear position, a speed, MDPS torque, an SPAS switch, and the like.

Therefore, the parking support unit 40 may display and provide the driver with the vehicle movement trajectory from the present vehicle position to the optimal parking space through the parking path calculated by the control unit 30, i.e., the parking path.

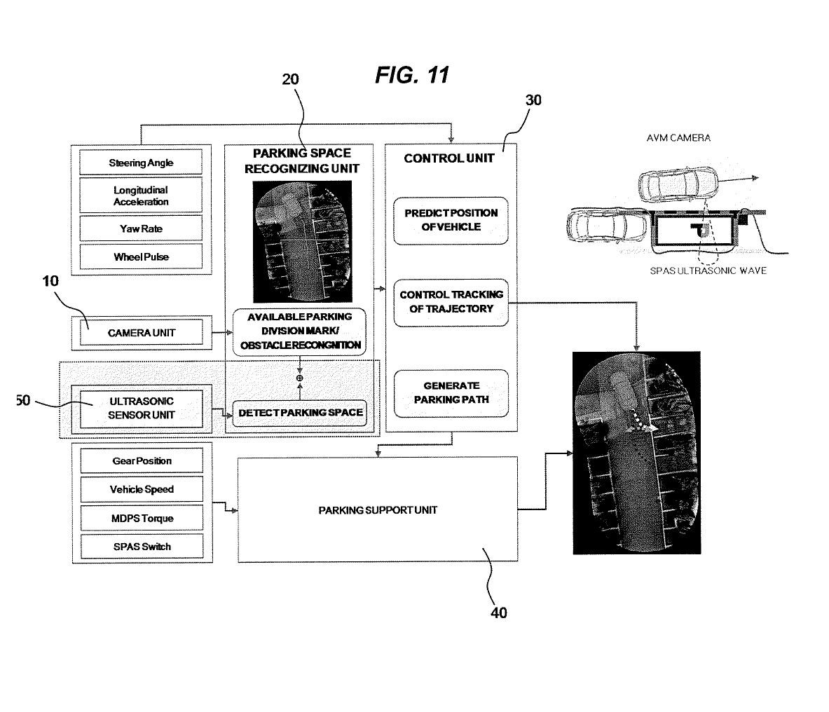

FIG. 11 shows another exemplary embodiment of the present invention.

In another exemplary embodiment of the present invention, as shown in the figure, the parking space recognizing unit 20 may interlock with an ultrasonic sensor unit 50 including an SPAS system using a known ultrasonic sensor. In other words, in searching the parking space and recognizing the obstacle within the parking space, data of the ultrasonic sensor unit is used to recognize an available parking division and recognize an obstacle while interlocking with the ultrasonic sensor unit, thereby improving accuracy and rapidity. In the present exemplary embodiment, the control unit and the parking support unit are configured to perform the same functions as the control unit 30 and the parking support unit 40 of FIG. 1.

Although the AVM top view based parking support system according to the exemplary embodiment of the present invention has been described in detail, it just presents a predetermined example to assist understanding of the present invention and is not intended to limit the scope of the present invention. In addition to the exemplary embodiments disclosed herein, it is apparent to those skilled in the art to which the present invention pertains that other modified examples based on the spirit of the present invention can be made.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An AVM (Around View Monitoring) top view based parking support system using AVM, comprising:
a camera unit including the AVM and photographing and acquiring images around a vehicle by using the AVM, and converting and synthesizing the acquired images into top view images;
a parking space recognizing unit recognizing a parking space by periodically receiving the top view images generated from the camera unit and comparing top view images that are sequentially continuous by using an image recognition technology;
a control unit receiving vehicle traveling information from each sensor of the vehicle and determining and generating a parking path based on the vehicle traveling information with respect to the parking space recognized from the parking space recognizing unit; and
a parking support unit receiving steering information of the vehicle and converting a display of the parking path generated in the control unit to correspond to the steering information.

2. The AVM top view based parking support system of claim 1, further comprising:
an ultrasonic sensor unit including an ultrasonic sensor and recognizing the parking space through the ultrasonic sensor,
wherein the ultrasonic sensor unit interlocks with the parking space recognizing unit, and
wherein the parking space recognizing unit further uses data of the ultrasonic sensor unit in recognizing the parking space.

3. The AVM top view based parking support system of claim 1, wherein the parking space recognizing unit extracts feature points of continuous images by using an image recognition technology, matches feature points of two continuous images, deletes mismatched feature points, and matches effective feature points to recognize the parking space.

4. The AVM top view based parking support system of claim 1, wherein the control unit determines a parking position by considering a parking trajectory and the number of forward/backward movement times by matching the vehicle traveling information with the parking space recognized from the parking space recognizing unit.

5. The AVM top view based parking support system of claim 4, wherein the control unit determines whether an obstacle exists within the parking space by judging a difference in the periodically received top view images.
